(19) United States
(12) Patent Application Publication
(10) Pub. No.: US 2024/0409420 A1
(43) Pub. Date: Dec. 12, 2024

(54) METHOD FOR SYNTHESIZING TITANIUM DIBORIDE POWDER

(71) Applicant: SAINT-GOBAIN CENTRE DE RECHERCHES ET D'ETUDES EUROPEEN, COURBEVOIE (FR)

(72) Inventors: Mangesh Ramesh AVHAD, COURBEVOIE (FR); Emmanuel NONNET, COURBEVOIE (FR); Laurie SAN-MIGUEL, COURBEVOIE (FR)

(21) Appl. No.: 18/698,269

(22) PCT Filed: Oct. 4, 2022
(86) PCT No.: PCT/FR2022/051873

§ 371 Date: Apr. 3, 2024

(30) Foreign Application Priority Data
Oct. 4, 2021 (FR) 2110464

(51) Int. Cl. C01B 35/04; C04B 35/58

(52) U.S. Cl. CPC C01B 35/04; C04B 35/58071; C01P 2002/70; C04B 2235/3813; C04B 2235/5436; C04B 2235/602

(57) ABSTRACT

A method for synthesizing a TiB₂ powder includes the reduction of titanium oxide by carbon in the presence of a source of boron, the method includes heating a mixture of a carbon source, a boron carbide powder whose median particle diameter is between 5 and 100 microns and a powder of titanium oxide whose median particle diameter is between 5 and 80 microns, the mixture being placed in an enclosure under an inert gas sweep flow rate between 0.5 and 10 L/min/m/m³ of enclosure at a temperature of between 1500° C. and 2000° C., as well as the TiB₂ powder obtained by such a method.

The invention relates to a novel method for manufacturing or synthesizing titanium diboride.

Titanium diboride is a ceramic material having a low density (about 4.5 g/cm³), a high hardness, a high thermal conductivity and a low electrical resistivity. This makes it a potentially interesting material for several applications, in particular shielding and antiballistic protection, refractory applications where the thermal conduction and the high electrical conduction are an asset, in particular heat exchangers, the coating or even the composition of anodes or of cathodes of electrolysis reactors, or even membranes in certain temperature applications or in very aggressive chemical media, as well as the cutting tools of metals, in particular for non-ferrous metals, or cutting tools.

All these applications explain that the demand for this material is very high and currently increasing.

TiB₂ does not exist in the natural state. The titanium diboride can be obtained for example by direct reaction of titanium (or its oxides or hydrides) with elemental boron at 1,000° C. or by carbothermic reduction of titanium oxide and boron oxide. In the latter case, the reaction consists of reacting a mixture of powders according to the following simplified reaction at a temperature above 1500° C.:

TiO₂(s)+B₂O₃(s)+5C(s)→TiB₂(s)+5CO(g) (1)

However, this method has a theoretical material efficiency of only about 30%.

Another less known method consists in particular in replacing the boron oxide powder with boron carbide, as shown by the following balance reaction:

2TiO₂+B₄C+3C→2TiB₂+4CO (2)

The advantage of such a reaction is its better theoretical material yield (55.4%) and therefore release of less carbon monoxide, but it has the disadvantage of requiring a higher reaction temperature.

The source of titanium oxide is generally a mineral source with a content greater than 95% TiO₂. The carbon source is generally and preferentially petroleum coke (petroleum distillation residue) or carbon black. Boron carbide is also a synthetic material available on the market of carbide powders, in particular abrasives.

However, methods for manufacturing this material are all the more expensive and energy-consuming as the final powder of titanium diboride obtained becomes finer (typically with a median diameter between 5 and 50 micrometers) or ultra-fine (median diameter less than 5 micrometers).

The article “Synthesis and consolidation of titanium diboride”, published in the international review “Journal of Refractory Metals and Hard Materials 25 (2007) page 345-350 by C. Subrmania et al.” suggests, for example, a method making it possible to obtain a very pure final powder (content of oxygen, of nitrogen and of carbon of the order of 0.5%). The method consists of reacting a mixture of high-purity powders (majority compound content greater than 95%), titanium oxide with a median diameter of 0.8 micrometers, boron carbide with a median diameter of 6.7 micrometers and petroleum coke in an organic solvent dried and then heated to a temperature of at least 1,800° C. and in a vacuum corresponding to a residual pressure of less than or equal to 4·10⁻⁵ mbar. Below this temperature, the powder obtained is too pure. This article teaches the use of reagent powder of fine (submicron) particle size and therefore more reactive, in particular titanium oxide, to improve the reaction yield and kinetics.

Another solution for better controlling the reaction consists of a method with an excess of B₄C of at least 10%, or even 20%, by mass relative to the stoichiometric theoretical amount required for the reaction (1). This additional addition makes it possible to fill the loss of boron in gaseous form at high temperature and reduces the presence of TiC and residual carbon but penalizes the actual material yield of the method.

The purpose of the invention is thus to improve the synthesis method described above and illustrated by equation (2), in order to obtain a pure fine TiB₂ powder, that is, one with a mass percent greater than 95%, or even very pure, that is, with a purity of greater than or equal to 98%, said powder having a low elemental oxygen content and advantageously also a low elemental carbon content, while retaining a high material yield, without resorting to an industrially complex powder synthesis process.

In particular, according to a first aspect, the present invention relates to an alternative method for manufacturing TiB₂ at a temperature below 2000° C., satisfying this purpose by virtue of particular atmosphere conditions and an appropriate choice of starting powders without any catalysis or surfactant additive.

More specifically, the present invention relates to a method for manufacturing a TiB₂ powder, comprising reducing titanium oxide by carbon in the presence of a source of boron, said method of heating a mixture of raw materials comprising, and preferably consisting of:
a) a titanium oxide powder, preferably in the form of a powder, the TiO₂ mass percent of which is at least 95% by mass, and
b) a carbon source, preferably one whose carbon mass percent is at least 90%, and
c) a boron carbide powder preferably having a B₄C mass percent of at least 90%, preferably at least 95%,
   at a temperature above 1500° C., preferably above 1600° C., and below 2000° C., preferably below 190° C.
   in respective proportions leading to the reduction of the titanium oxide to titanium boride according to the following balance reaction:

2TiO₂+B₄C+3C→2TiB₂+4CO (2)
said method being characterized in that:
   the median particle diameter of the boron carbide powder is between 5 and 100 microns, and
   the median particle diameter of the titanium oxide powder is between 5 and 80 microns, and
   the excess boron carbide is less than 5% by mass, preferably less than 2% by mass, relative to the stoichiometric amount necessary for said reaction (2),
   the synthesis is carried out in an enclosure under an inert gas flow,
   the flow rate of the gas flow in said enclosure is between 0.5 and 10 L/min per m³ of enclosure.

According to the invention, the inert gas is brought into the enclosure in contact with the mixture of raw materials. The present invention lies in the choice not only of the particle size of the starting powders described above but also in the selection of the preceding particular synthesis conditions, such a combination advantageously making it possible to obtain a fine TiB₂ powder of high purity with a maximum material yield, as will be described in more detail below.

The method of the invention particularly comprises one or more of the following preferred features:
The median particle diameter of the boron carbide powder is greater than 7 micrometers, preferably greater than or equal to 10 micrometer.
The median particle diameter of the boron carbide powder is less than 80 microns, preferably less than 50 microns, or even less than 30 microns.
The median particle diameter of the titanium oxide powder is greater than 7 micrometers, preferably greater than or equal to 10 micrometers.
According to a preferred embodiment, the median particle diameter of the boron carbide powder is greater than 7 micrometers and the median particle diameter of the titanium oxide powder is greater than 7 micrometers,
the median particle diameter (D₅₀) of the titanium oxide powder is less than 50 micrometers, preferably less than 30 micrometers.
The diameter D₉₀ of particles of the boron carbide powder is less than 100 micrometers, preferably less than 80 micrometers, preferably less than or equal to 50 micrometers, more preferably less than or equal to 40 micrometers,
The diameter D₉₀ of particles of the titanium oxide powder is less than 100 micrometers, preferably less than 80 micrometers, preferably less than or equal to 50 micrometers, more preferably less than or equal to 40 micrometers,
The ratio of the median particle diameter of the boron carbide powder to the median particle diameter of the titanium oxide powder is greater than 0.8, preferably greater than or equal to 1.
The ratio of the median particle diameter of the boron carbide powder to the median particle diameter of the titanium oxide powder is less than 5, preferably less than 2.
The titanium oxide powder is a rutile or anatase powder, preferably rutile.
The mass percent of SiO₂+Al₂O₃+ZrO₂ in the titanium oxide powder is less than 5%.

In particular, the content of SiO₂ in the titanium oxide powder by mass is preferably less than or equal to 2%. The mass percent of Al₂O₃ in the titanium oxide powder is preferably less than or equal to 2%, preferably less than 1%. The mass percent of ZrO₂ in the titanium oxide powder is preferably less than or equal to 1%.
The elementary oxygen content of the boron carbide powder is less than or equal to 5%, preferably less than 3%, more preferably less than 2%.
The carbon source is chosen from cokes, in particular petroleum coke, coal or from biomass, graphite or carbon black.
The mass percent of elementary carbon in the carbon source is greater than 95%, preferably greater than 97%.
The carbon source, if it is in the form of coke, has undergone a dehydrogenation treatment such that its mass percent of elemental hydrogen according to the ISO/TS 12902 standard is less than 1% and very preferably less than 0.5%, or even less than 0.1%. Preferably, the content is less than 10 ng/mg for each of the following HAP compounds: Naphthalene, Acenaphtene, Fluorene, Phenanthracene, Chrysene, Anthracene, Pyrene, Benz[a]anthracene, Benzo[a]pyrene, Dibenzo(a,h)Anthracene, Benzo[ghi]perylene, Benzo[k]fluoranthene, Fluoranthene, Benzo[b] fluoranthene and In(1,2,3,c,d,)P).
The raw materials were dried beforehand at a temperature between room temperature and 150° C.
The synthesis temperature is greater than or equal to 1600° C. and preferably less than 1800° C.
The pressure of the enclosure is kept virtually constant, for example between 0.5 and 1.5 bars and even more preferably the enclosure is at atmospheric pressure (1 bar).
The gas sweeping the enclosure wherein the mixture is placed is preferably a noble gas, for example argon or helium, preferably argon. The flow rate measured under normal pressure and temperature conditions is preferably from 0.5 to 5 L/min per m³ of enclosure, preferably between 0.5 and 3 L/min per m³, preferably between 0.5 and 2 L/min per m³ of enclosure. Too low a sweep leads to an incomplete reaction, and more particularly to undesirable carbon residues present in the final powder of titanium diboride. Too high a flow rate penalizes the yield of the reaction (2) by requiring an upper energy supply to accompany the chemical reaction kinetics. A gas sweep flow rate of 0.5 to 10 L/min per m³ of enclosure is more particularly suitable for a reactor with an energy power typically comprised between 20 and 80 KW. Such a reactor is used to heat a mixture that can range up to 500 g for a volume of enclosure equal to 2.5 liters.
An inert sweep gas flow rate of 0.005 to 1 L/min per m³ of enclosure and per KW of heating power of the enclosure is particularly optimal, preferably between 0.01 and 0.5/min per m³ of enclosure and per kW of heating power of the enclosure.

According to a first possible mode, an addition of alkali metal salt can be carried out, for example according to proportions of between 0.5 and 15%, preferably between 5 and 15%, by mass of metal relative to the total mass of the carbon source, of the particles of the boron carbide powders and of the titanium oxide particles. This supply reduces the presence of agglomerates in the synthesis powder which are likely to disrupt the step of firing the sintered ceramic body obtained from this TiB₂ synthesis powder.

An addition of alkali metal salt of less than 0.5% is insufficient to a temperature greater than 1500° C., in particular between 160° and 2000° C. A supply of greater than 15% leads to excessive evaporation of the boron during the synthesis of the TiB₂ powder.

According to an advantageous embodiment of the present invention, the alkali metal is chosen from Li, Na, K. Preferably, the alkali metal salt is an alkali metal halide, preferably a chloride. More preferably, it is sodium chloride.

The median size of the alkali metal salt particles is preferably between 0.5 and 100 micrometers, more preferably between 5 and 50 micrometers.

The invention also relates to a TiB₂ powder obtained according to the preceding method. The median particle diameter of this powder is between 0.5 and 50 microns, and it comprises the following elementary mass percents:
titanium(Ti): greater than 67%,
boron(B): greater than 28%,
oxygen (O): less than 1.3%, preferably less than 1.2%
carbon (C): less than 0.5%
nitrogen (N): less than 0.5%
sulfur (S): less than 400 ppm, preferably less than 300 ppm or even less than 150 ppm,
iron (Fe): less than 0.45%,
preferably a sum Li+Na+Rb+Cs of less than 1%,
preferably a sum of the other elements is less than 2%,
Preferably, the sum of oxygen (O)+nitrogen (N)+carbon (C) is less than 1.5%, or even less than or equal to 1.2%.

Such a TiB₂ powder of high purity and of defined particle size makes it possible to obtain by sintering a sintered ceramic body having a total porosity of less than 7% by volume without the use of the addition of transition metals such as Ni, Fe or Co which are capable of resulting in the formation of secondary metal borides from these metals which are not desired.

A powder obtained with the preceding method, to which alkali metal salt was added during the synthesis of the powder, in the proportion as specified above, has a very high homogeneity which results in a very low crystal size dispersion. Such a powder makes it possible to obtain a sintered ceramic body in the form of a part, at least one dimension of which, preferably all of the overall dimensions, is greater than 5 cm, or even greater than 10 cm, and having a total porosity also less than 7%, a very narrow pore size distribution, without deformation on sintering and without shrinkage cracking.

Preferably, the TiB₂ powder according to the invention further comprises one or more of the following elementary mass percents:
titanium (Ti): greater than 68% and/or less than 72%,
boron (B): greater than 29% and/or less than 33%,
carbon (C): less than 0.5%,
oxygen (O): less than 1%, preferably less than 0.5%, or sulfur (S) less than 300 ppm, less than 100 ppm, preferably less than 50 ppm,
nitrogen (N): less than 0.5%,
iron (Fe): less than 0.4%,
preferably phosphorus (P): less than 0.3% preferably less than 0.2%, preferably less than 0.1%
preferably silicon (Si): less than 0.1%, preferably less than 500 ppm,
alkaline earth (Be+Mg+Ca+Sr+Ba): less than 0.25%,

Said TiB₂ powder further comprises a SiC content of less than 1%, preferably less than 0.5%, and a TiC content of less than 1%, preferably less than 0.5%,

The TiB₂ powder according to the invention does not comprise a crystallized phase such as B₄C or TiC phases, or Ti₂O₃, Ti₃B₄, SiC as measured (detectable) by X-ray diffraction. Preferably, said powder comprises only a crystalline phase of TiB₂, as measured (detectable) by X-ray diffraction.

The invention also relates to a mixture comprising between 90 and 99.9% by mass or even consisting of the TiB₂ powder according to the invention and between 0.1 and 10% by mass of one or more sintering powders chosen from aluminum diboride, magnesium diboride, zirconium diboride, tungsten pentaboride, calcium hexaboride, silicon hexaboride, preferably whose purity is greater than 95% by mass, preferably greater than 98% by mass.

A purity greater than 95% by mass is that of said phase or of the most stable main compound: for example, in the case of a powder of aluminum diboride, more than 95% by mass of AlB₂ or for a tungsten pentaboride powder, containing more than 95% by mass of W₂B₅.

The invention likewise relates to a method for manufacturing a sintered ceramic body, comprising the following steps:
a) preparing a starting feedstock comprising:
   the TiB₂ powder as obtained by a method according to the invention or a mixture of powders as described above comprising said powder and one or more of said sintering powders.
   an aqueous solvent, in particular deionized water,
   preferably, shaping additives,
b) shaping the feedstock into the form of a preform, preferably by pressing,
c) removal from the mold after setting or drying;
d) optionally, drying the preform, preferably until the residual moisture content is comprised between 0 and 0.5% by weight,
e) loading in a furnace and firing the preform under an inert atmosphere, preferably under argon, or under vacuum, preferably at a temperature between 1600° C. and 2200° C.

The invention also relates to the sintered ceramic body thus obtained and the use of the sintered ceramic body obtained by the preceding method as all or part of a membrane, in particular for the filtration of liquids or gases, a shielding or an anti-ballistic protection element, a covering or a refractory block, an anode coating or block or a cathode coating or block, in particular an electrolysis reactor, a heat exchanger, a metal melting crucible, in particular for non-ferrous metal, a cutting tool.

The following indications and definitions are given in connection with the preceding description of the present invention:
In the present description, unless otherwise specified, all the percentages are given by weight, on the basis of dried material.
The material yield is calculated by dividing the obtained TiB₂ mass of raw powder by the theoretical mass of TiB₂ raw powder which would have been obtained from that of the dry mixture of powder of the reagents (moisture less than 2%) before heat treatment. For example, under stoichiometric conditions according to the reaction (2), a yield of 100% corresponds to a mass of crude powder of 55.4 g starting from a mixture of 100 g composed of titanium oxide, carbon, and boron carbide powders.
Crude powder means the powder directly obtained at the outlet of the enclosure after heating and reaction of the mixture and before optional additional treatment such as screening or grinding for example.
The median diameter (or the median “size”) of the particles constituting a powder is given within the meaning of the present invention by characterizing the particle size distribution, in particular by means of a laser particle sizer. The characterization of particle size distribution is conventionally carried out with a laser particle size analyzer in accordance with the ISO 13320-1 standard. The laser particle size analyzer can be, for example, a Partica LA-950 from HORIBA. For the purposes of the present description and unless otherwise mentioned, the median particle diameter respectively denotes the diameter of the particles below which 50% by mass of the population is found. “Median diameter” or “median size” of a set of particles is called a powder, the D₅₀ percentile, that is, the size dividing the particles into first and second populations equal in volume, these first and second populations comprising only particles having a size greater than, or less than, respectively, the median size.
the contents of elementary chemicals can be determined according to the ISO 21068:2008 standard.

In particular:
the contents of O, N C, and S are measured by analyzer of the LECO® brand,
the contents of Si, alkali, alkaline-earth Fe, P can be determined by ICP (Induction Coupled Plasma),
the contents of B and Ti are preferably determined by ICP.
the presence and relative content of TiB₂ but also other crystallized compounds can be determined conventionally by X-ray diffraction analysis.
the total porosity of a ceramic body is the ratio, expressed as a percentage, of the bulk density measured for example according to ISO 18754 to the absolute density measured for example according to ISO 5018.

Unless otherwise specified, all percentages in this description are mass percentages.

### FIGURES

FIG. 1 shows the crude powder after synthesis without adding NaCl according to example 2 according to the invention.

FIG. 2 shows the crude powder after synthesis including adding NaCl according to example 4 according to the invention.

FIG. 3 shows a reactor 1 allowing the implementation of the present method, comprising an enclosure 2 in order to sweep the mixture 3 with an inert gas 4 by heating it to obtain the crude powder according to the invention.

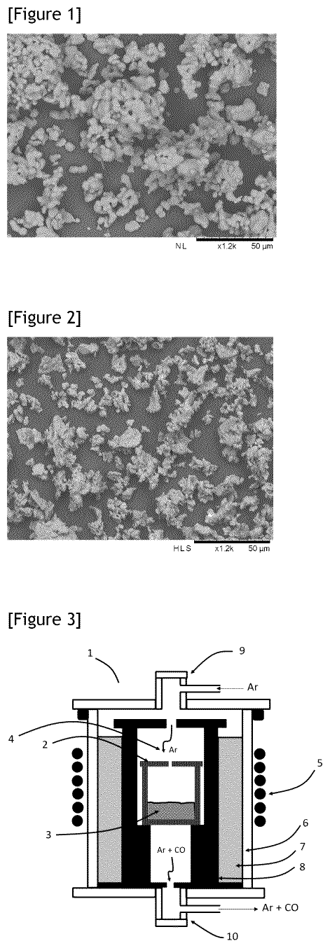

### DETAILED DESCRIPTION

The invention and its advantages will be better understood on reading the detailed description given below. Of course, the present invention is not limited to such a mode, in any of the aspects described below.

The starting mixture comprising a carbon source (for example carbon black, the C mass percent of which is greater than 90%, preferably greater than 95%), a powder of titanium oxide (for example a rutile or anatase powder, the TiO₂ mass percent of which is greater than 95%) and a boron carbide powder (for example a powder whose B₄C mass percent is greater than 90%), is carried out under standard conditions for the person skilled in the art. This step of preparing the dry mixture allows intimate contact of the particles. According to one possible embodiment, it is carried out in a ball mixer or in a tumbler mixer or other devices known to the person skilled in the art. Prior co-grinding can be carried out to adjust the particle size of the starting raw materials if necessary.

The median size of the boron carbide, titanium oxide, and carbon particles is respectively between 10 and 100 microns, between 5 and 80 microns and between 0.1 and 1 microns. Preferably, the median size of the boron carbide and titanium oxide particles is greater than 7 micrometers, greater than 8 micrometers, greater than 9 micrometers and/or less than 70 micrometers, less than 50 micrometers, less than 30 micrometers.

Preferably, the median size ratio of the boron carbide and titanium oxide particles is between 0.8 and 1.2.

Preferably, a mixture according to the invention comprises, in mass percent, respectively 62 to 65% titanium oxide, 21 to 23% boron carbide and 13 to 15% carbon, in particular in the form of carbon black.

The mixture according to the invention has an excess of B₄C less than 5% relative to the stoichiometry of the reaction (2), calculated according to the invention on the basis of the amount of TiO₂ introduced into said mixture.

Optionally, an alkali metal salt, preferably an alkali metal halide, in particular NaCl, is added in a proportion of between 0.5 and 15% by mass of metal relative to the preceding mass of mixture comprising boron carbide particles and titanium oxide and a carbon source.

The mixture is preferably air-dried, preferably at a temperature above 40° C., more preferably at a temperature above 100° C., in order to obtain a mixture whose moisture content is less than 2%, preferably less than 1%.

The mixture is placed in an enclosure in the form of an inert crucible 2, preferably of graphite, open in order to make the inert gas 4 sweep therein, the assembly being placed for example in an induction furnace 1 as shown in the attached FIG. 3. The induction furnace 1 is equipped with copper turns 5 placed around a quartz tube 6 inside which a fibrous thermal insulator 7 and a graphite susceptor 8 are placed. The inert gas is brought by a distributor 9. A discharge 10 allows the inert gas to flow and the reaction gases to be recovered, mainly CO. The loose density of the mixture before heat treatment measured according to the ASTM D7481-18 standard is preferably greater than 0.5, greater than 0.6, greater than 0.7 and/or preferably less than 2.0, less than 1.8. Preferably, the mixing volume represents less than 30% of the total volume of the enclosure in order to improve the circulation of the inert gas and the release of the gases produced by the reaction (2). A temperature rise is carried out up to at least 1500° C., preferably at least 1600° C. under an inert atmosphere, preferably under-sweeping of an inert gas, in particular Argon, the gas being brought into contact with the mixture. Preferably, the inert gas sweeping is carried out at a normal flow rate of 0.5 and 5 L/min per m³ of enclosure, preferably between 0.5 and 3 L/min/m³, preferably between 0.5 and 2 L/min/m³ of enclosure.

Preferably, the temperature rise is less than 20° C./minute, preferably less than 10° C./minute. This temperature rise ramp, like the duration of the plateau, can be adjusted as a function of the mixing volume and the power of the reactor.

The maximum thermal treatment temperature is preferably between 160° and 2000° C., preferably between 160° and 1800° C. Preferably, the plateau at the maximum temperature is at least one hour, preferably at least two hours.

Preferably, an intermediate plateau is carried out between 60° and 1000° C., and/or a lower ramp, typically at least twice as low, is carried out after 600° C. in order to prevent the removal of the mixture and promote the reaction between the particles.

The cooling can be free or forced, preferably according to a negative ramp less than 20° C./min.

According to the method of the invention, the material yield is greater than 80%, or even greater than 90% or even greater than 95%, or even greater than or equal to 98%.

The crude powder obtained has a particle size of typically between 10 and 100 micrometers. An operation of sieving or of light crushing or of vibration makes it possible to eliminate the aggregates and to obtain a finely divided powder whose median diameter is between 0.5 and 50 micrometers, of large purity and very homogeneous. After milling, it is possible to obtain a micron-sized powder whose size dispersion is very reduced because of a narrow crystallite size.

A powder obtained with the preceding method, to which alkali metal salt was added during the synthesis of the powder, in the proportion as specified above, has a very high homogeneity which results in an even lower crystal size dispersion.

The final powder of TiB₂ in particular has a high purity and a very reduced particle size dispersion making it possible to obtain by sintering a sintered ceramic body having a total porosity of less than 7% by volume without the use of the addition of transition metals such as Ni, Fe or Co while exhibiting a very low electrical resistivity.

The powder obtained according to the method of the invention also makes it possible to obtain a sintered ceramic body in the form of a part, all of the dimensions of which are at least one dimension greater than 5 cm without deformation upon sintering and without shrinkage cracking.

A method for manufacturing a sintered ceramic body using the powder according to the invention in particular comprises the following steps:
a) preparing a starting feedstock comprising:
   the TiB₂ powder according to the invention or a mixture of powders as described above, comprising said powder and one or more sintering powders, in particular chosen from aluminum diboride, magnesium diboride, zirconium diboride, tungsten pentaboride, calcium hexaboride, silicon hexaboride, the purity of said TiB₂ powder being greater than 95% by mass, preferably greater than 98% by mass, said TiB₂ powder preferably representing at least 90% of the total mass of the feedstock.
   an aqueous solvent, in particular deionized water,
i. less than 20% of the total mass of the feedstock in the case of shaping by casting,
ii. less than 15% of the total mass of the feedstock in the case of shaping by extrusion,
iii. less than 10%, preferably less than 7% of the total mass of the feedstock in the case of a press-forming,
   preferably, forming additives such as binders such as PVA (polyvinyl alcohol), plasticizers (such as polyethylene glycol), lubricants,
b) shaping the feedstock into the form of a preform, preferably by pressing, extrusion, or pouring,
c) removal from the mold after setting or drying;
d) optionally, drying the preform, preferably until the residual moisture content is comprised between 0 and 0.5% by weight,
e) loading in a furnace and firing the preform under an inert atmosphere, preferably under argon, or under vacuum, preferably at a temperature between 1600° C. and 2200° C., preferably according to a temperature rise ramp of less than 20° C./minute, preferably less than 10° C./minute. This temperature rise ramp, like the duration of the plateau, can be adjusted as a function of the mixing volume and the power of the reactor.

Any shaping technique known to the person skilled in the art can be applied as a function of the dimensions of the part to be made as soon as all the precautions are taken to avoid contamination of the preform. Thus, the casting in a plaster mold can be adapted by using graphite media between the mold and the preform or oils avoiding excessive contact and abrasion of the mold by mixing and finally contamination of the preform. These controlled precautions for use by a person skilled in the art are also applicable to other steps of the method. Thus, during sintering, the mold or the matrix used containing the preform will preferably be made of graphite.

Hot pressing, hot isostatic pressing, or SPS (Spark Plasma Sintering) techniques are particularly suitable.

The following examples are for illustrative purposes only and do not limit the scope of the present invention in any of the aspects described.

### EXAMPLES

### Example 1 (Comparative)

The starting mixture was made with a powder of titanium oxide with a mass percent of greater than 95% of TiO₂ and of median diameter D₅₀ of 0.8 μm mainly in a rutile crystallographic form, a powder of B₄C with a mass percent greater than 98% of B₄C and a median diameter D₅₀ equal to 7 μm and petroleum coke, according to the following respective mass proportions 64.53% of TiO₂, 22.59% of B₄C and 12.89% of C. Such a mixture corresponds to an excess of boron carbide of 1.2%. An isopropanol solvent was added in order to subsequently obtain granules according to the teaching of the publication of the Journal International Journal of Refractory Metals and Hard Materials 25 (2007) page 345-350 by C. Subrmania et al.

Two mixture samples were subjected to a heat treatment without a particular sweep and in a vacuum of 4·10⁻⁵ mbar in a furnace according to a plateau duration of 2 h respectively at a temperature of 1600° C. and 1820° C.

### Example 2 (According to the Invention)

A mixture was prepared under the same conditions as above, but without the granulation step after heat treatment, the milling being 3 minutes instead of 30 minutes. Furthermore, the starting powders consist of a powder of titanium oxide with a mass percent of greater than 95% of TiO₂ (the remainder being essentially SiO_{2<2}%, Al₂O₃<2%, ZrO₂<1%, and traces of Fe) and of median diameter D₅₀ of 10 μm; powder of B₄C with a mass percent greater than 98% B₄C and a median diameter D₅₀ of 15 μm and a carbon black powder of median diameter D₅₀ of 0.2 μm according to the following respective mass proportions 63.6% TiO₂, 22.1% B₄C and 14.3% C. Such a mixture corresponds to an excess of boron carbide of 0.5% relative to the stoichiometry of the reaction. Two samples of mixtures were placed in a graphite crucible described above according to FIG. 3 serving as an enclosure respectively subjected to a heat treatment at 1600° C. and 1800° C. according to a 2 h plateau duration in a furnace under an argon sweep flow of 1.25 L/min/m³.

### Example 3 (Comparative)

The starting mixture was carried out as in example 2, but the heat treatment was carried out without any particular sweep and in a vacuum of 4·10⁻⁵ mbar in a furnace according to a 2 h plateau duration at a temperature of 1600° C.

### Example 4 (According to the Invention)

This example differs from example 2 in that the starting mixture comprises a further addition of NaCl representing 10% by weight of the dry mixture before heat treatment at 1600° C.

### Example 5 (Comparative)

This example differs from example 2 in that the starting mixture comprises a titanium oxide powder of greater size before heat treatment at 2000° C.

For each of these examples, the raw powder mixture is then slightly crushed and sieved in order to separate the agglomerates to obtain a powder of particles, except for example 4 for which sieving alone was sufficient.

### Example 6 (Comparative)

This example differs from example 2 according to the invention in that argon sweeping is adjusted to 0.25 L/min/m³.

### Example 7 (Comparative)

This example differs from example 2 according to the invention in that a powder of B₄C of purity >98% B₄C by mass and median diameter D₅₀ of the order of 150 μm.

### Example 8 (Comparative)

This example differs from example 2 according to the invention in that the respective mass proportions of titanium oxide powder, of B₄C powder, and carbon black are the following 62.5% of TiO₂, 23.2% of B₄C and 14.3% of C. The excess of B₄C relative to the stoichiometry of the reaction is about 7.7%.

The material yield was carried out according to the procedure described above in the application. The features of the method are compiled in table 1 which follows.

The properties of the final powders obtained are presented in table 2 below.

TABLE 1

| | | | | | | | | |
|---|---|---|---|---|---|---|---|---|
| | Ex. 1 | Ex. 2 | Ex. 3 | Ex. 4 | Ex. 5 | Ex. 6 | Ex. 7 | Ex. 8 |
| Diameter | (comp.) | (inv.) | (comp.) | inv. | (comp.) | (comp.) | (comp.) | (comp.) |

recycled raw materials

| | | | | | | | | | |
|---|---|---|---|---|---|---|---|---|---|
| Titanium | D₅₀ μm | 0.8 | 10 | 10 | 10 | 150 | 10 | 10 | 10 |
| oxide | D₉₀ μm | N.M | 30 | 30 | 30 | 250 | 30 | 30 | 30 |
| powder | | | | | | | | | |
| Boron | D₅₀ μm | 6.7 | 15 | 15 | 15 | 15 | 15 | 150 | 15 |
| carbide | D₉₀ μm | NM | 30 | 30 | 30 | 30 | 30 | 220 | 30 |
| powder | | | | | | | | | |
| Carbon | D₅₀ μm | 18 | 0.2 | 0.2 | 0.2 | 0.2 | 0.2 | 0.2 | 0.2 |
| powder | D₉₀ μm | NM | 0.3 | 0.3 | 0.3 | 0.3 | 0.3 | 0.3 | 0.3 |
| NaCl | D₅₀ μm | N.A | N.A | N.A | 10 | N.A | N.A | N.A | N.A |
| powder | D₉₀ μm | | | | 30 | | | | |
| Excess | % | 1.2 | 0.5 | 0.5 | 0.5 | 0.5 | 0.5 | 0.5 | 7.7 |
| B₄C/Stoech. | | | | | | | | | |
| of reaction | | | | | | | | | |

Heat treatment

| | | | | | | | | | |
|---|---|---|---|---|---|---|---|---|---|
| T max. | ° C. | 1600/1820 | 1600/1800 | 1600 | 1600 | 2000 | 1600 | 1600 | 1600 |
| Ramp | ° C./min | 10 | 5 | 5 | 5 | 5 | 5 | 5 | 5 |
| Platform | h | 3 | 2 | 2 | 2 | 2 | 2 | 2 | 2 |
| Atmosphere | | Vacuum | Argon | Vacuum | Argon | Argon | Argon | Argon | Argon |
| Pressure | mbar | 4 · 10⁻⁵ | Atmos. | 4 · 10⁻⁵ | Atmos. | Atmos. | Atmos. | Atmos. | Atmos. |
| sweep flow | L/min/m³ | none | 1.25 | none | 1.25 | 1.25 | 0.25 | 1.25 | 1.25 |
| rate | enclosure | | | | | | | | |
| Yield | % | 60 | 98 | 63 | 98 | 66 | 78 | <70 | N.M |

N.M not measured;
N.A not applicable = atmospheric pressure

TABLE 2

| | | | | | | | |
|---|---|---|---|---|---|---|---|
| Ex. 1 | Ex. 2 | | | | | | |
| (comp.) | (inv.) | Ex. 3 | Ex. 4 | Ex. 5 | Ex. 6 | Ex. 7 | Ex. 8 |
| 1600/ | 1600/ | (comp.) | (inv.) | (comp.) | (comp.) | (comp.) | (comp.) |
| 1820° C. | 1820° C. | 1600° C. | 1600° C. | 2000° C. | 1600° C. | 1600° C. | 1600° C. |

Physical properties of the powder obtained after grinding (3 min)

| | | | | | | | | |
|---|---|---|---|---|---|---|---|---|
| D₅₀ powder | 0.8 | 2.2/2.9 | 1.8 | 1.8 | 3.8 | N.M | 3.8 | N.M |
| D₉₀ powder | 1.5 | 4.8/5.2 | 4.5 | 5.0 | 9.4 | N.M | 9.4 | N.M |

Mass % final powder chemistry

| | | | | | | | | |
|---|---|---|---|---|---|---|---|---|
| Ti (%) | >67/>67 | >67 | >67 | >67 | >67 | N.M | N.M | N.M |
| B(%) | NM | 32/31.8 | 28 | 32.1 | 32 | N.M | N.M | N.M |
| O LECO | 2 to 4/0.5 | 0.8/0.5 | 0.2 | 1.2 | 2.3 | N.M | N.M | 2.1 |
| (%) | | | | | | | | |
| C Total | 2 to 4/0.6 | 0.3/0.2 | 5.0 | 0.1 | 5.0 | 5.5 | 5.3 | 6.4 |
| LECO (%) | | | | | | | | |
| N LECO | NM/0.5 | 0.1/0.1 | 0.2 | 0.1 | 0.1 | 0.1 | 0.1 | 0.1 |
| (%) | | | | | | | | |
| S LECO | NM | 300/150 | 150 | 30 | 900 | 300 | 300 | 300 |
| (ppm) | | | | | | | | |
| Fe (ppm) | NM | 785 | 5000 | 2200 | 3900 | N.M | N.M | N.M |
| Li + Na + | NM | 500 | <500 | <500 | <500 | N.M | N.M | N.M |
| Rb + Cs(ppm) | | | | | | | | |
| Be + Mg + | NM | <500 | <500 | <500 | <500 | N.M | N.M | N.M |
| Ca + Sr + | | | | | | | | |
| Ba (ppm) | | | | | | | | |
| P (ppm) | NM | <500 | <500 | <500 | <500 | N.M | N.M | N.M |
| Si (ppm) | NM | <500 | <500 | <500 | <500 | N.M | N.M | N.M |
| XR Diffr. | TiB₂, | TiB₂ | TiB₂, | TiB₂ | TiB₂, | N.M | TiB₂, | TiB₂, |
| Phases | Ti₂O₃, | only | Ti₂O₃, | only | B₄C, C | | B₄C | B₄C |
| | Ti₃B₄, C | | Ti₃B₄, C | | traces of | | | |
| | | | | | SiC | | | |
| Actual | NM | 4.4/4.4 | 4.4 | 4.4 | 4.4 | 4.4 | 4.4 | 4.4 |
| density | | | | | | | | |

N.M. = not measured

It can be seen in the data reported in Tables 1 and 2 that the TiB₂ powders obtained by the method according to the invention are very pure and virtually free of contaminants (in particular oxygen, nitrogen, carbon, sulfur) further with a very good yield from the reaction.

Ceramic bodies were produced from the powders according to the preceding examples 2, 4, 6 and 8 (those obtained at 1600° C.) and two other ceramic bodies were produced according to the same method as described below, but the first from the commercial Höganas powder of grade SE and the second from the powder Japan New Metals of grade NF.

Each powder was mixed with 0.25% of a pressing additive (PVA) and 4.75% of deionized water by mass relative to the mass of titanium diboride powder in order to be cold-pressed under a pressure of 100 bar and to form a cylinder with a diameter of 30 mm and a thickness of 10 mm. After demolding, each cylinder was dried at 110° C. for 24 hours and then fired without pressure at a temperature of 1850° C. for 12 h in Argon.

The porosity of the sintered bodies obtained was determined by dividing the ratio expressed as a percentage of the bulk density measured for example according to ISO 18754 to the absolute density measured according to ISO 5018. The electrical resistivity is measured at room temperature (20° C.) according to the Van der Pauw method at 4 points on a sample with a diameter of 20-30 mm and a thickness of 2.5 mm.

The properties of the final powders obtained are presented in table 3 below.

TABLE 3

| Powder | example 2 | example 4 | | Japan | example 6 | example 8 |
|---|---|---|---|---|---|---|
| employed | (invention) | (invention) | Hogänas | New Metals | (comparative) | (comparative) |
| (obtaining T°) | (1600° C.) | (1600° C.) | SE | NF | 1600° C. | 1600° C. |
| Mass % final powder chemistry | | | | | | |
| O LECO (%) | 0.8 | 1.2 | 1.5 | 1.4 | N.M | 2.1 |
| C LECO (%) | 0.3 | 0.1 | 0.5 | 0.4 | 5.5 | 6.4 |
| N LECO (%) | 0.1 | 0.1 | 0.7 | 0.6 | 0.1 | 0.1 |
| S LECO (ppm) | 300 | 30 | NM | NM | 900 | 900 |
| Physical properties of the sintered body obtained | | | | | | |
| Total porosity | 4.5 | 4.7 | 39.9 | 25.6 | >20 | >20 |
| % vol. | | | | | | |
| Resistivity at | 0.12 | 0.20 | 0.55 | 0.23 | 0.31 | 0.35 |
| 25° C. (micro- | | | | | | |
| ohm · m) | | | | | | |

N.M. = not measured

On reading the results reported in the preceding tables, it is observed that the sintered bodies according to the invention have a very low resistivity and a porosity that is much lower than that of the bodies obtained with commercially available TiB₂ powders. Furthermore, the grains of TiB₂ used have levels of contaminants (elementary oxygen, carbon and nitrogen in particular) well below those obtained by a method as described in the prior art. These advantages were able to be obtained from a powder according to the invention after simple grinding following the heat treatment, without resorting to an additional granulation step.

1. A method for manufacturing a TiB₂ powder, comprising reducing titanium oxide by carbon in the presence of a source of boron, said method comprising heating a mixture of raw materials consisting of:
a) a titanium oxide (TiO₂) powder, and
b) a carbon source, and
c) a boron carbide powder,
at a temperature above 1500° C. and below 2000° C.,
in respective proportions leading to the reduction of the titanium oxide to titanium boride according to the balance reaction:
2TiO₂+B₄C+3C→2TiB₂+4CO (2)
wherein:
a median particle diameter of the boron carbide powder is between 5 and 100 microns, and
a median particle diameter of the titanium oxide powder is between 5 and 80 microns, and
an excess boron carbide is less than 5% by mass relative to the stoichiometric amount necessary for the reaction (2)
the synthesis is carried out in an enclosure under an inert gas flow,
a flow rate of the inert gas flow in said enclosure is between 0.5 and 10 L/min per m³ of enclosure.

2. The method for the synthesis of a TiB₂ powder, according to claim 1, wherein the median particle diameter of the boron carbide powder is greater than 7 micrometers and/or less than 80 micrometers.

3. The method for the synthesis of a TiB₂ powder, according to claim 1, wherein the median particle diameter of the titanium oxide powder is greater than 7 micrometers and/or less than 50 micrometers.

4. The method for the synthesis of a TiB₂ powder, according to claim 1, wherein a ratio of the median particle diameter of the boron carbide powder to that of the titanium oxide powder is greater than 0.8 and/or less than 5.

5. The method for the synthesis of a TiB₂ powder, according to claim 1, wherein the titanium oxide powder has a SiO₂+Al₂O₃+ZrO₂ mass percent less than 5%.

6. The method for the synthesis of a TiB₂ powder, according to claim 1, wherein the carbon source is chosen from cokes.

7. The method for the synthesis of a TiB₂ powder, according to claim 1, wherein the inert gas sweep flow rate is 0.005 to 1 L/min/m³ of enclosure/kW of heating power of the enclosure.

8. The method for the synthesis of a TiB₂ powder, according to claim 1, wherein the inert gas is a noble gas.

9. The method for the synthesis of a TiB₂ powder, according to claim 1, wherein an alkali metal salt is added to the mixture in a proportion of between 0.5 and 15% by mass of metal relative to the mass of the carbon source and of the particles of the boron carbide and titanium oxide powders.

10. The method for the synthesis of a TiB₂ powder, according to claim 1, wherein said mixture comprises, in mass proportion, 62 to 65% of titanium oxide (TiO₂), 21 to 23% of boron carbide (B₄C) and 13 to 15% of carbon (C).

11. A TiB₂ powder obtained according to the method of claim 1, the median diameter of which is between 0.5 and 50 micrometers and the chemical composition of which comprises the following elementary mass percents:
titanium(Ti): greater than 67%,
boron(B): greater than 28%,
oxygen (O): less than 1.3%,
carbon (C): less than 0.5%
nitrogen (N): less than 0.5%
sulfur (S): less than 400 ppm,
iron (Fe): less than 0.45%,
a sum Li+Na+Rb+Cs of less than 1%,
a sum of the other elements less than 2%.

12. The TiB₂ powder according to claim 11, wherein the sum of oxygen (O)+nitrogen (N)+carbon (C) is less than 1.5%.

13. The TiB₂ powder according to claim 11, wherein the median diameter is between 0.5 and 50 micrometers and the chemical composition of which comprises the following elementary mass percents:
titanium (Ti): greater than 68% and less than 72%,
boron (B): greater than 29% and less than 33%,
carbon (C): less than 0.5%,
oxygen (O): less than 1% or sulfur (S): less than 300 ppm,
nitrogen (N): less than 0.5%
iron (Fe): less than 0.4%.

14. A TiB₂ powder according to claim 11, comprising only a crystalline phase of TiB₂, as measured by X-ray diffraction.

15. A mixture comprising between 90% and 99.9% by mass of a TiB₂ powder according to claim 11 and between 0.1 and 10% by mass of one or more sintering powders chosen from aluminum diboride, magnesium diboride, zirconium diboride, tungsten pentaboride, calcium hexaboride.

16. A method for manufacturing a sintered ceramic body, comprising the following steps:
a) preparing a starting feedstock comprising:
the TiB₂ powder according to claim 11,
an aqueous solvent,
b) shaping the starting feedstock into the form of a preform;
c) removal from the mold after setting or drying;
d) optionally, drying the preform,
e) loading in a furnace and firing the preform under an inert atmosphere.

17. A sintered ceramic body obtained by a method according to claim 16.

18. A method comprising providing the sintered ceramic body according to claim 17 as all or part of a membrane, a shielding or an anti-ballistic protection element, a covering or a refractory block, an anode coating or block or a cathode coating or block, a heat exchanger, a metal melting crucible.

19. The method for the synthesis of a TiB₂ powder, according to claim 1, wherein
a) the titanium oxide (TiO₂) powder has a TiO₂ mass percent of which is at least 95%, and
b) the carbon source has a carbon mass percent that is at least 90%, and
c) the boron carbide powder has a B₄C mass percent of at least 90%.

20. The method for the synthesis of a TiB₂ powder, according to claim 6, wherein the carbon source is chosen from petroleum coke, coal or from biomass, graphite or carbon black.
